(19) United States
(12) Patent Application Publication
(10) Pub. No.: US 2018/0247324 A1
(43) Pub. Date: Aug. 30, 2018

(54) Retail Product Distribution Systems and Methods Thereof

(71) Applicant: Wal-Mart Stores, Inc., Bentonville, AR (US)

(72) Inventors: Nicholaus A. Jones, Fayetteville, AR (US); Matthew A. Jones, Bentonville, AR (US)

(21) Appl. No.: 15/883,307

(22) Filed: Jan. 30, 2018

Related U.S. Application Data
(60) Provisional application No. 62/464,770, filed on Feb. 28, 2017.

(51) Int. Cl. G06Q 30/02; G06Q 10/06; G06Q 10/08; G06Q 30/08

(52) U.S. Cl. CPC G06Q 30/0205; G06Q 10/06311; G06Q 30/0206; G06Q 30/08; G06Q 10/0875

(57) ABSTRACT

In some embodiments, apparatuses and methods are provided herein useful to ascertain what products to sell in particular physical stores, where to shelve those products, and/or the amount of product to order from a vendor to improve customer satisfaction and store sales. In some embodiments, a retail store is configured to use electronic auction data (which may be generated from the retail store's own online auction platform or received from a third party) to determine aspects of the distribution system. Furthermore, the aggregated auction data may be analyzed by a geographic area such that demand for a particular geographic area may be determined and the regional product demand may be used to automate and quickly update aspects of the distribution system.

### CROSS-REFERENCE TO RELATED APPLICATION(S)

This application claims the benefit of U.S. Provisional Application No. 62/464,770, filed Feb. 28, 2017, which is incorporated by reference in its entirety herein.

### TECHNICAL FIELD

This invention relates generally to distributing products in retail shopping facilities.

### BACKGROUND

Customer loyalty can be critical to retail facility success. Through customer loyalty a retail facility can achieve repeat visits and purchases by customers. Further, improving access to products and improving the product offerings can have a significant effect on customer satisfaction. Further, improving product offerings can further bolster store sales, in addition to improving the customer experience.

### BRIEF DESCRIPTION OF THE DRAWINGS

Disclosed herein are embodiments of systems, apparatuses and methods pertaining to retail product distribution systems and methods thereof. This description includes drawings, wherein:

FIG. 1 is a schematic illustration of an exemplary system for distribution of retail products in accordance with some embodiments.

FIG. 2 is an exemplary flow diagram in accordance with several embodiments.

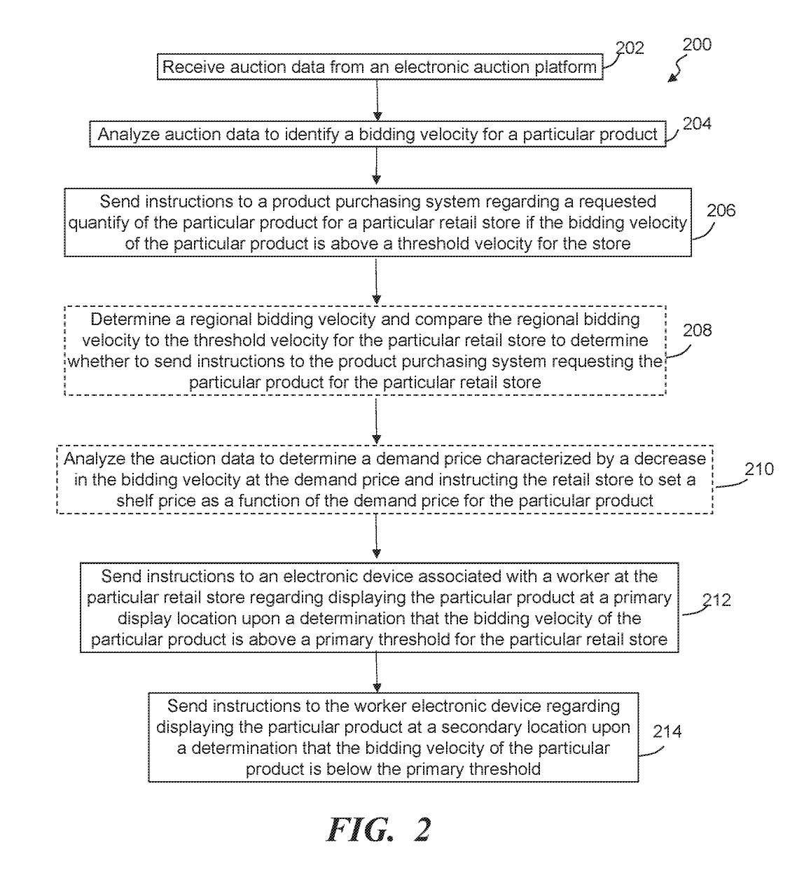

FIG. 3 is an exemplary flow diagram in accordance with some embodiments.

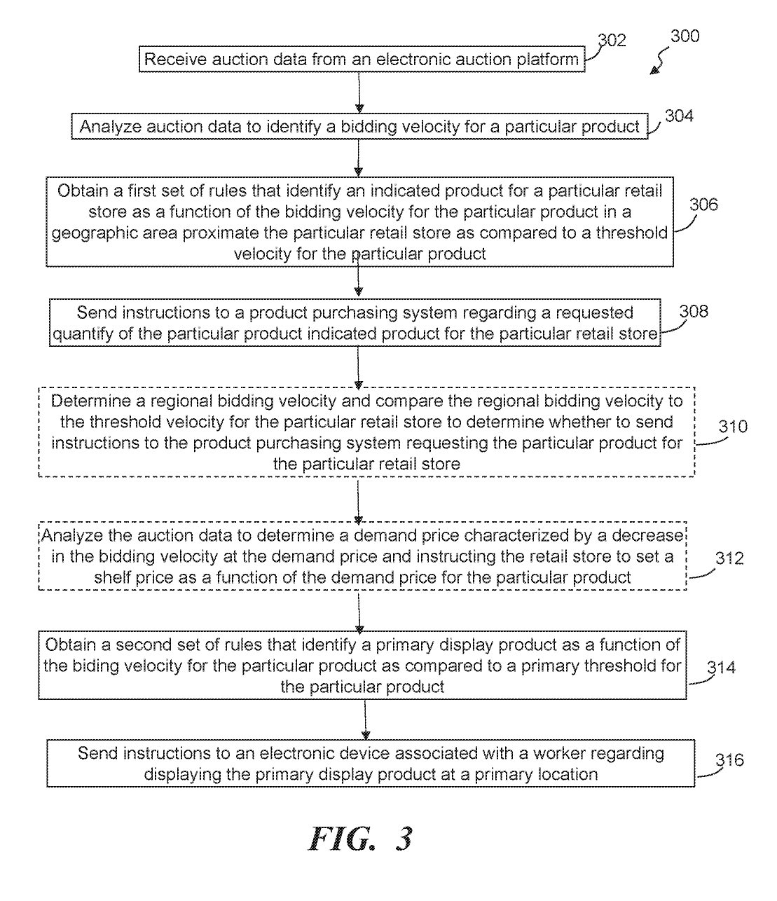

FIG. 4 is schematic flow diagram in accordance with some embodiments.

FIG. 5 illustrates an exemplary system for use in implementing systems, apparatuses, devices, methods, techniques, and the like for distributing products to customers in accordance with some embodiments.

Elements in the figures are illustrated for simplicity and clarity and have not necessarily been drawn to scale. For example, the dimensions and/or relative positioning of some of the elements in the figures may be exaggerated relative to other elements to help to improve understanding of various embodiments of the present invention. Also, common but well-understood elements that are useful or necessary in a commercially feasible embodiment are often not depicted in order to facilitate a less obstructed view of these various embodiments of the present invention. Certain actions and/or steps may be described or depicted in a particular order of occurrence while those skilled in the art will understand that such specificity with respect to sequence is not actually required. The terms and expressions used herein have the ordinary technical meaning as is accorded to such terms and expressions by persons skilled in the technical field as set forth above except where different specific meanings have otherwise been set forth herein.

### DETAILED DESCRIPTION

Generally speaking, pursuant to various embodiments, systems, apparatuses and methods are provided herein useful to determine what merchandise to sell at a physical retail store. Offering products of interest to customers can improve customer experience and improve product sales. In some embodiments, a retail store is configured to use electronic auction data (which may be generated from the retail store's own online or electronic auction platform or may be received from a third party auction platform) to ascertain the products to be sold within a physical retail store, the display or shelf location of the products sold, the amount of products to purchase from a vendor, and/or a price with which to sell the product in the retail store. Further, to facilitate rapid response to changing customer demand, aspects of the distribution system may occur automatically in light of auction data received. In some configurations, this auction data may be analyzed according to a specific geographic or regional area around a particular retail facility such that the distribution system may tailor the product selection, price, shelf location, and quantity of products ordered for that particular retail facility according to online bidding data from registered auction users in the particular regional area. In other configurations, auction data for a similar socioeconomic area may be used to select products, prices, shelf location, and quantity of products for a physical retail facility outside of the geographic area, based on the area's substantial socioeconomic similarity.

By one approach, a retail product distribution system includes a shopping user interface that is configured to operate on an electronic user device and the shopping user interface is configured to provide an auction platform to registered users that register with the auction platform. Further, the retail product distribution system generally includes a product database having product records stored therein and a control circuit in communication with the product database. In one illustrative embodiment, the control circuit is configured to receive auction data including a bidding velocity for a particular product, a location of bidding users, and delivery location from the auction platform. The control circuit may then analyze the auction data and compare the bidding velocity of users for the particular product with a threshold velocity. In addition, the control circuit is configured to send instructions to a product purchasing system regarding a requested quantity of the particular product for a particular physical retail store if the bidding velocity of the particular product is above the threshold velocity, send instructions to an electronic device of a worker of the retail store regarding displaying the particular product at a primary display location if the bidding velocity of the particular product is above a primary threshold, and send instructions to the electronic device regarding displaying the particular product at a secondary display location if the bidding velocity of the particular product is below the primary threshold. As noted below, the instructions may be sent automatically from the control circuit after comparing the bidding velocities and the thresholds so that the system quickly responds quickly to receipt of auction data that it receives and analyzes.

In this manner, the retail product distribution system analyzes the aggregated auction data to automatically determine the products to sell in a store and also may further use the information to automatically determine the number of products or amount of merchandise to request from a vendor, where to shelve the product, and the sale price for the product, which may be determined on a regional basis by analyzing auction data for a specific geographic area. The auction data may include, for example, a number of views of the particular product, an initial bid price, number of bids received, times and amounts associated with the bids received, a winning bid, and an auction length in addition to bidding velocity and a location of the bidding users.

While in some configurations the auction data received may specifically include bidding velocities for particular products, in other configurations the auction data may include information sufficient to calculate bidding velocities, such as product bid amounts and their time of submission. As used herein, the bidding velocity is the number of bids received in a certain period of time. In this manner, the auction data can tell you how quickly and in what amounts or increments the bid or price has increased. In an electronic auction, bids are typically received at a relatively fast pace up until a particular bid threshold has been reached. Calculating a bidding velocity up to a certain bid threshold helps determine customer interest in an item as a function of price. Generally, if an item is continuously bid upon up to a certain price, it will generally sell fairly well in the store for at least that particular price, if the in-store shoppers are sufficiently similar to the online auction shoppers. Also, as noted below, the aggregated auction data may be used to determine which products to prominently display in the physical retail store. For example, products or merchandise having slower or lower relative bidding velocity may be shelved in less prominent shelf space.

Further, in some embodiments, the control circuit is configured to analyze the regional bidding velocity and compare it with the threshold velocity of at least one physical retail store within the particular geographic area. In one configuration, with the auction data, the control circuit is configured to analyze at least one of the registered location of bidding users or the delivery location for the particular product to determine a regional bidding velocity for a particular geographic area.

As used herein, the auction platform is understood to be operable on an electronic device of a user and is configured to present products for auction to the registered users of the shopping user interface and provide a predetermined, limited period of time for the users to bid on the products presented. In operation, the electronic, online auction platform generally sets a starting price or starting bid and permits the registered users or bidders to place bids over the Internet for the goods or products being auctioned. Typically, the auction ends once the time limit has been reached and the goods are sold to the highest bidder at that time. The auction platform is typically configured to register users or potential bidders, such as by setting up an account, at which time the user may provide a location or address information, such as a zip code (which may be subsequently analyzed by the control circuit when determining a regional bidding velocity). Further, the location information and other user information, may be correlated with the user's bids, amounts, and other details.

The online auction platform and the distribution system described herein permit a retail store to quickly respond to consumer demand and judiciously use retail store stock space for items of interest to customers. Also, the auction data may be supplemented by historical purchase data or other information to help determine the merchandise to sell, the price at which to sell the merchandise, and where to shelve the merchandise. For example, the systems and methods may determine the products and their associated prices based on a store's location and the associated auction data for that region. While auction platforms often sell products at a bit of a discount, as compared to the selling price at a physical retail shopping facility, the information captured during the auction can be aggregated and analyzed to help determine consumer demand for products. Further, the aggregated auction data can be analyzed so that more popular products are incorporated into the inventory of a physical retail store, which typically improves store sales.

As noted above, the product distribution systems described herein typically use aggregated auction data to identify products of particular interest to particular customers and may break down the identified products as a function of geographic area. For example, a particular flavor or scent of a particular product may be in high demand in a particular region. Furthermore, the auction data may be used to help the system gauge a customer's level or amount of interest. By one approach, the control circuit is further configured to analyze the auction data to determine a demand price characterized by a decrease in the bidding velocity at the demand price. With this information, the control circuit, in one approach, sends instructions to the particular physical retail store to set a shelf price for the particular product as a function of the demand price. For example, the shelf price may be set a certain percentage below the demand price. Alternatively, as the sale price for auction items is sometimes lower than an outright purchase price, the shelf price may be set a certain amount above the demand price.

In another embodiment, the product database further includes historical sales information. Furthermore, the control circuit, in some approaches, is configured to analyze the historical sales information and the auction data to determine how much product to order. The control circuit may then automatically transmit a request for a particular quantity of product to the product purchasing system.

As noted above, the control circuit may be configured to automatically request or send instructions to the product purchasing system. In this manner, the retail distribution system is able to quickly respond to customer demand. Whereas previous approaches to retail product distribution may have estimated customer interest in particular product, such as, for example, based on customer inquiries at the physical retail store, these teachings, by analyzing auction data and automatically sending instructions or requesting items from vendors, permit the retail store to quickly respond to or anticipate customer demand.

In another aspect, the control circuit is further configured to receive additional auction data from the auction platform and analyze the additional auction data to determine updated the bidding velocity. With this additional information, the control circuit, in some configurations, sends instructions to the worker electronic device regarding moving a displayed product from a first location to a second location based on the bidding velocity of the displayed particular product.

To provide a retail product distribution system that efficiently anticipates and responds to anticipated customer demands, the system may be configured to automatically order products and determine display location for the ordered products based upon the analyzed auction data. To that end, the retail product distribution system may include a product database having product records stored therein and a control circuit in communication with the product database and a product purchasing system. The control circuit, in one configuration, receives auction data (which may include a number of views of a product, delivery location of the product sold, an initial bid price, number of bids received, times and amounts associated with the bids received, a winning bid amount, and an auction length) and analyzes the auction data to identify a bidding velocity for a particular product in a regional area by identifying locations of bidding users. For example, by limiting an analysis of the auction data to bidding users in a particular geographic area, the system may determine a regional bidding velocity.

In such an operation, the control circuit also obtains a first set of rules that identify an indicated product for a particular retail store as a function of the bidding velocity for the particular product in the regional area proximate the particular retail store as compared to a threshold velocity for products at the particular retail store, sends instructions to a product purchasing system requesting a quantity of the indicated product for the particular retail store, and obtains a second set of rules that identify a primary display product as a function of the bidding velocity in a regional area for the particular product as compared to a primary threshold for products at the particular retail store, and sends instructions to an electronic device associated with a worker regarding displaying the primary display product at a primary display location. In this manner, the system is able to identify customer demand for a product within a particular geographic area and respond to the customer demand within that region. Accordingly, though online auctions oftentimes result in the seller receiving a lower price for the sale of particular goods, the auction data gathered can be used to assist the retail distribution system in identifying products of greater interest for a particular geographic area, which may increase sales at retail stores. The auction data also may help the system more accurately predict stock needs for various retail stores.

By one approach, the control circuit also is configured to generate a planogram for a retail store having primary and secondary display locations determined as a function of the bidding velocity associated with various products, relative bidding velocity, and the locations of bidding users. In another approach, the control circuit is configured to update the product database to include the indicated product as being shelved at the particular retail store.

In a first step, the control circuit may determine what products to stock at a physical retail store (e.g., looking at what products to offer in particular regions) and then may analyze where to shelve the products in a second step. The shelving analysis for new products that are being added to the store shelves may be different than for products historically sold at a particular retail facility. For example, if a new product is added to the inventory of a particular store and the bidding velocity for that retail product in the geographic area of the particular store is above a primary threshold, the control circuit may instruct the associates or workers in the retail store to shelve the product at a primary display location. Further, if the auction data indicates that a product historically shelved in a single, somewhat inconvenient location in the retail store, has a bidding velocity above a primary threshold, the control circuit may instruct the associate or worker to move the product's shelf location, such as to a primary display location and update the planogram accordingly. In this way, the auction data is not merely used to determine what products to offer within the store, but can provide insights about where to offer products within a store to improve sales.

In one exemplary approach, a method for determining whether and where to stock retail products includes receiving, at a control circuit, auction data (including, e.g., a number of views of a particular product, location of bidding users, an initial bid price, a number of bids received for a particular item, times and amounts associated with the bids received, a winning bid amount, location of the bidders, time to sell and an auction length) from an electronic auction platform, analyzing the auction data to identify a bidding velocity for the particular product, and sending instructions to a product purchasing system regarding a requested quantity of the particular product for a particular retail store if the bidding velocity of the particular product is above a threshold velocity for the particular retail store. By one approach, the method includes sending instructions to an electronic device associated with a worker at the particular retail store regarding displaying the particular product at a primary display location upon a determination that the bidding velocity of the particular product is above a primary threshold for the particular retail store and sending instructions to the worker electronic device regarding displaying the particular product at a secondary display location upon a determination that the bidding velocity of the particular product is below the primary threshold.

In some embodiments, the method includes determining a regional bidding velocity and comparing the regional bidding velocity to the threshold velocity for the particular retail store to determine whether to send instructions to the product purchasing system requesting the particular product for the particular retail store. As mentioned above, the regional bidding velocity may be ascertained by examining the bidding rate of bidding users in a particular geographic area as determined by the registered user information or the shipping location of winning bids.

By some approaches, the methods described herein may analyze auction data to determine a demand price characterized by a decrease in the bidding velocity at the demand price and instructing the retail store to set a shelf price as a function of the demand price for the particular product.

In another exemplary approach, a method for determining whether and where to stock retail products includes receiving, at a control circuit, auction data (including, e.g., including, e.g., a number of views of a particular product, location of bidding users, an initial bid price, a number of bids received for a particular item, times and amounts associated with the bids received, a winning bid amount, location of the bidders, time to sell and an auction length) from an electronic auction platform, identifying a bidding velocity for the particular product, and obtaining a first set of rules that identify an indicated product for a particular retail store as a function of the bidding velocity for the particular product in a geographic area proximate the particular retail store as compared to a threshold velocity for the particular product. In such a configuration, the method generally includes sending instructions to a product purchasing system regarding a requested quantity of the indicated product for a particular retail store, obtaining a second set of rules that identify a primary display product as a function of the bidding velocity for the particular product as compared to a primary threshold for the particular product, and sending instructions to an electronic device associated with a worker regarding displaying the primary display product at a primary display location.

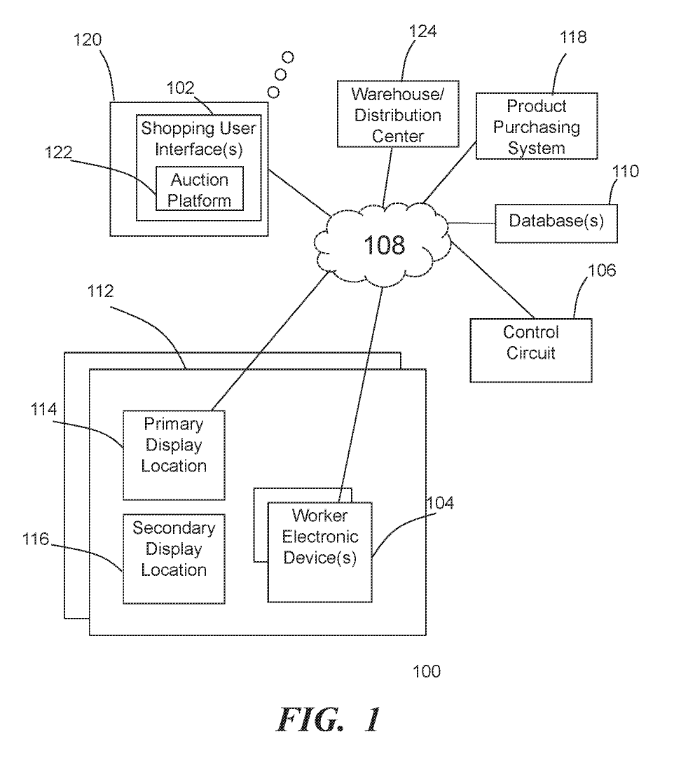

FIG. 1 illustrates a simplified block diagram of an exemplary retail product distribution system 100 that permits product selection to occur automatically, in quick response to the receipt of auction data, such that up-to-date product offerings are presented in a physical retail store and presented in a manner that permit customer's easy, convenient access to products of interest. As shown, a control circuit 106 is in communication with a shopping user interface 102 operable on an electronic user device 120. The shopping user interface 102 has an auction platform 122 associated therewith, which provides goods for which registered users can bid. The auction platform 122 generally tracks the online bidding and sales of the products in the auctions and then provides that aggregated auction data to the control circuit 106 and/or the database(s) 110, which also is in communication with the control circuit 106.

The database(s) 110 typically include a product database with product records stored therein. The product records typically include information about the product itself and also may include historical sales information about the products, numbers of products ordered (such as via a product purchasing system 118 discussed below), and/or regional sales information about the product, e.g., the amount of product sold over a particular period of time in particular geographic areas. Further, the control circuit, in some configurations, analyzes the historical sales information, along with the auction data, to determine how much of a particular product to order or request, such as via the product purchasing system.

As noted above, the control circuit 106, in one exemplary approach, receives auction data from the auction platform and analyzes the auction data by comparing a bidding velocity for a particular product with a threshold velocity for a particular retail store or product. If the bidding velocity for the particular product is at or above the threshold velocity, the control circuit 106, in one configuration, automatically orders the product, such as, for example, by automatically sending instructions to a product purchasing system 118 requesting a quantity of the particular product. In some configurations, this particular product may be intended for a particular physical retail store 112. Earmarking requested retail product for particular physical retail stores is particularly helpful when the auction data has been analyzed from a regional or geographic perspective.

As used herein, the product purchasing system 118 may be in communication with vendors such that orders, requests, purchase orders, and the like can be submitted to the vendors to initiate procurement of the particular requested retail item. The product purchasing system 118 also may coordinate with a distribution center 124, which may have a quantity of the particular retail product (if this is a product that is already sold in at least some retail stores or online) by the retailer. For example, if the control circuit 106 determines that regional interest in a particular product is fairly high, as illustrated by a high regional bidding velocity, the control circuit 106 and/or the product purchasing system 118 may direct product from the distribution center 124 to the particular physical retail store 112 in a particular geographic area. The product purchasing system 118 also may consider the product located at various distribution centers 124, along with auction data, to determine how much of a particular product to order from a vendor.

As noted above, the auction data can be useful in determining where to display or shelve products. For example, the aggregated auction data may inform where new products should be added to the inventory in initial display locations or may inform the retail store workers where products previously shelved should be moved. Both of these situations may require an update to the store planogram or model of the physical retail store 112.

To provide the store associates or workers guidance regarding where to shelve particular products, in addition to having a planogram, the control circuit 106 may automatically send instructions to a worker's electronic device 104 regarding displaying a particular product at a particular location, such as a primary display location 114 if the biding velocity of that product is above a primary threshold or at a secondary display location 116 if the bidding velocity of that product is below the primary threshold. Such up-to-date information regarding shelving of the product may be particularly useful for products currently being sold at the physical retail facility (i.e., not those being newly added to the store's inventory) because sending instructions to update or change a shelf location in real-time in response to received auction data helps stores quickly respond to changing customer demand, as identified or captured in the aggregated auction data.

As illustrated in FIG. 1, the various devices of system 100 may communicate directly or indirectly, such as over one or more distributed communication networks, such as network 108, which may include, for example, LAN, WAN, Internet, cellular, Wi-Fi, and other such communication networks or combinations of two or more of such networks.

By analyzing aggregated auction data from the auction platform 122, the control circuit 106 can identify the location of bidding users or the delivery location for products purchased or won on the auction platform to determine a regional bidding velocity for a particular geographic area. With this information, the control circuit 106, in some embodiments, compares the regional bidding velocity with the threshold velocity of a particular physical retail store, e.g., a particular store threshold, within the particular geographic area to determine whether to sell or stock that product at that particular physical retail store.

As noted above, a discrepancy may exist between what customers are willing to pay for an item on an auction site as compared to their willingness to spend at a physical retail store. Nonetheless, the rate of change of the bidding velocity over time and amounts can help inform a physical retail store about a customer's willingness to spend on products. By one approach, the control circuit 106 analyzes the aggregated auction data to determine a demand price or the price at which the bidding velocity begins to decrease. In yet other configurations, the control circuit 106 is configured to analyze winning bid amounts. The control circuit 106 may analyze both the demand price and the winning bid amounts to determine what shelf price to set for a particular product. Furthermore, the control circuit 106 may analyze bids from a particular geographic area to determine a geographic demand price (or the price at which demand slowed in a particular geographic area) or the winning bid amounts for a geographic area to determine what shelf price to set for a particular product in a particular geographic area. In one illustrative approach, the control circuit 106 sends instructions to the particular physical retail store, such as through a worker electronic device 104, to set a shelf price for a particular product as a function of the demand price. As noted above, these instructions may be automatically sent so that the store stock, shelving locations, and prices are updated to reflect current customer demand.

The efficacy of the systems and processes described herein improve with regular receipt of aggregated auction data that is regularly analyzed to update the physical retail store stock, display or shelf locations, and prices quickly. Accordingly, the control circuit 106 is configured to receive and analyze additional auction data from the auction platform so that updated bidding velocities can be determine and updated instructions sent to the worker electronic device 104 and the product purchasing system 118. For example, the control circuit 106 may analyze additional aggregated auction data to determine that a particular product should be moved within the store and the control circuit 106 may send instructions to the worker electronic device 106 regarding moving the displayed product from a first location to a second location based on the change in bidding velocity of the displayed particular product.

The retail product distribution system 100, in one embodiment, automatically orders products according to a set of rules regarding bidding velocity and this may streamline the distribution system and its response to the information contained in the aggregated auction data. Further, the system 100 may automatically determine shelf locations for the ordered products and provide instructions to the store workers directing them accordingly.

In one illustrative approach, the system 100 includes a product database 110 with product records therein and a control circuit 106 in communication therewith, where the control circuit analyzes auction data to identify a bidding velocity for a particular product by region (e.g., by identifying locations of bidding users) and obtains a first set of rules that identify an indicated product for a particular retail store as a function of the bidding velocity for the particular product in the regional area proximate the particular retail store as compared to a threshold velocity for the particular product or retail store. For example, the first set of rules that are used to identified indicated products or products that the aggregated auction data indicate would sell well in the particular retail store compare the regional bidding velocity of the particular product with a store threshold velocity. The store threshold velocity may be determined in a number of manners, such as, for example, auctioning off several relatively high, medium, and low sales volume products on the auction platform to determine an estimated velocity for such categories and then setting the threshold velocity as a function of the bidding velocities measure. The primary display threshold discussed above may be set based on similar information. In another approach, the store threshold velocity and the primary display threshold velocity may be set based on historical data for a particular physical retail store, or a combination of factors including those described herein.

With this information, the control circuit 106, in such a configuration, sends instructions to a product purchasing system 118 regarding a requested quantity of the indicated product for the particular retail store. In such a configuration, the control circuit 106 also obtains a second set of rules that identify a primary display product as a function of the bidding velocity in a regional area for the particular product as compared to a primary threshold for the particular product or store and sends instructions to an electronic device 104 associated with a worker regarding displaying the primary display product at a primary display location.

Similarly, to quickly respond to consumer demand, the system 100 also may generate a planogram or generate an update to the planogram for the particular retail store with primary and secondary display locations determined as a function of the bidding velocity associated with various products, relative bidding velocity, and the location of bidding users. This information may be automatically sent to the physical retail store 112 and instructions automatically sent to workers stocking shelves, via a worker electronic device 104, to quickly update the store shelves. Further, the control circuit 106 may update the product database(s) 110 to include the indicated product (if added to the store stock) as being shelved at the particular retail store and in what location (e.g., updating the planogram in the product database 110).

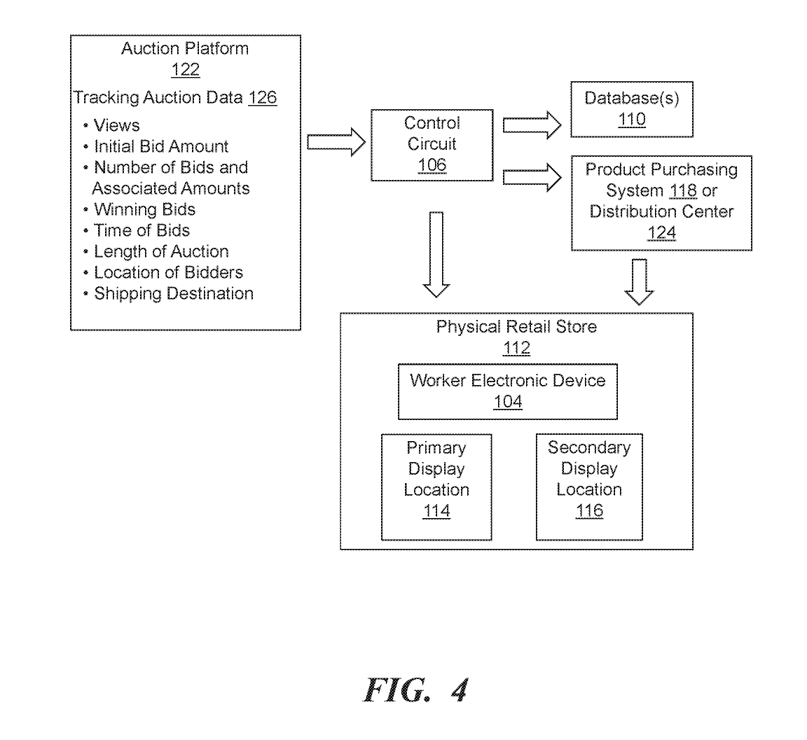

As shown in FIG. 4, the control circuit 106 receives aggregated auction data 126 from the auction platform 122 and the control circuit 106 can identify a bidding velocity and use that to ascertain whether a particular retail store should shelve items. For example, if the bidding velocity is below a particular store threshold, then the product is not added to the stock in that particular store if not already being offered for sale at that location and the particular store may consider whether to stop selling the product if already in stock, decrease the volume of product stocked, or move the product's display location in light of this information. Alternatively, if the particular bidding velocity is equal to or above the particular store threshold and below a primary display threshold, the product may be added to a store's stock and shelved in a secondary display location of the particular retail store. Furthermore, if the particular bidding velocity is above the primary display threshold for a particular store, steps are taken to automatically shelve the product at a primary display location.

The control circuit 106, as shown may send information regarding the aggregated auction data 126 and the analysis conducted by the control circuit 106 to the database(s) 110 and the product purchasing system 118. With that information, the products are sent from the product purchasing system 118 (e.g., sent indirectly from the vendors or the distribution center 124), and the instructions regarding where to display the products are sent to the physical retail store 112 from the control circuit 106. Further, the control circuit 106 automatically instructs the physical retail store 112 regarding whether to shelve a particular product in a primary display location 114 or a secondary display location 116. Further, as noted above the instructions may be sent to the worker electronic device 104, which also may confirm the products are properly shelved or displayed in the physical retail store 112 by sending a confirmation (e.g., sending a captured image of the primary display location to confirm proper placement) to the control circuit 106 and/or the database(s) 110.

In another exemplary embodiment, a method 200 is provided herein for ascertaining the products to stock in a store, an optimized display location for the products, the amount of product to order, and/or the price at which to sell to set for the products. Further, several steps of the distribution process may be automated such that they automatically occur upon receipt and analysis of the auction data, and in this way, the distribution system is capable of promptly responding to changing customer demand as captured by the auction data. By one approach, the method 200 includes receiving 202, at a control circuit, auction data from an electronic auction platform, such as platform 122 described above, and analyzing 204, via the control circuit, the auction data to identify a bidding velocity for the particular product. Further, the method 200 generally includes sending instructions 206 to a product purchasing system regarding a requested quantity of the particular product for a particular retail store if the bidding velocity of the particular product is above a threshold velocity for the particular retail store. Furthermore, the amount of requested merchandise may depend on or factor in the aggregated auction data, such as, for example, the bidding velocity, the winning bid, the number of bids, and the like.

In such a configuration, the method 200 also may determine 208 a regional bidding velocity and compare the regional bidding velocity to the threshold velocity for the particular retail store to determine whether to send instructions to the product purchasing system thereby requesting the particular product for the particular retail store. The method 200 also may analyze 210 the auction data to determine a demand price characterized by a decrease in the bidding velocity at the demand price and instructing the retail store to set a shelf price as a function of the demand price for the particular product. As noted steps 212 and 214 may occur automatically, though in other configurations, the system also may require verification from a system administrator prior to sending these instructions.

In operation, the method 200 generally sends instructions 212 automatically to an electronic device associated with a worker at the particular retail store regarding displaying the particular product at a primary display location upon a determination that the bidding velocity of the particular product is above a primary threshold for the particular retail store. Further, in step 214, the method sends instructions 214 automatically to the worker electronic device regarding displaying the particular product at a secondary display location upon a determination that the bidding velocity of the particular product is below the primary threshold.

In yet another exemplary embodiment, a method 300 is provided herein for ascertaining the products to stock in a store, an optimized display location for the products, the amount of product to order, and/or the price at which to sell the products. Further, several steps of the distribution process may be automated such that they automatically occur upon receipt and analysis of the auction data, and in this way, the distribution system is capable of promptly responding to changing customer demand as captured by the auction data. By one approach, the method 300 includes receiving 302, at a control circuit, auction data and analyzing 304 the auction data to identify a bidding velocity for a particular product. By one approach, the method 300 includes obtaining 306 a first set of rules that identify an indicated product for a particular retail store as a function of the bidding velocity for the particular product in a geographic area proximate the particular retail store as compared to a threshold velocity for the particular store or product. With this information, in step 308, the method sends instructions 308 to a product purchasing system regarding a requested quantity of the indicated product for a particular retail store. Further, in step 310, the method may determine 310 a regional bidding velocity and compare the regional bidding velocity to the threshold velocity for the particular retail store to determine whether to send instructions to the product purchasing system requesting the particular product for the particular retail store. In step 312, the method may include analyzing 312 the auction data to determine a demand price characterized by a decrease in the bidding velocity at the demand price and instructing the retail store to set a shelf price as a function of the demand price for the particular product. In addition, the method 300 typically includes obtaining 314 a second set of rules that identify a primary display product as a function of the bidding velocity for the particular product as compared to a primary threshold for the particular product and sending instructions 316 to an electronic device associated with a worker regarding displaying the primary display product at a primary display location.

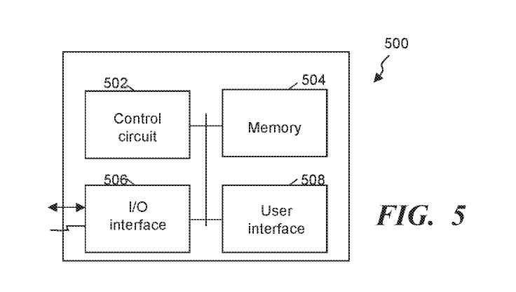

The methods, techniques, systems, devices, services, servers, sources and the like described herein may be utilized, implemented and/or run on many different types of devices and/or systems. Referring to FIG. 5, there is illustrated a system 500 that may be used for any such implementations, in accordance with some embodiments. One or more components of the system 500 may be used to implement any system, apparatus or device mentioned above, or parts of such systems, apparatuses or devices, such as for example any of the above or below mentioned control circuits, electronic user devices, sensor(s), databases, platforms, parts thereof, and the like. However, the use of the system 500 or any portion thereof is, certainly not required.

By way of example, the system 500 may include one or more control circuits 502, memory 504, input/output (I/O) interface 506, and/or user interface 508. The control circuit 502 typically comprises one or more processors and/or microprocessors. The memory 504 stores the operational code or set of instructions that is executed by the control circuit 502 and/or processor to implement the functionality of the systems and devices described herein, parts thereof, and the like. In some embodiments, the memory 504 may also store some or all of particular data that may be needed to deliver retail products outside of a retail facility.

It is understood that the control circuit 502 and/or processor may be implemented as one or more processor devices as are well known in the art. Similarly, the memory 504 may be implemented as one or more memory devices as are well known in the art, such as one or more processor readable and/or computer readable media and can include volatile and/or nonvolatile media, such as RAM, ROM, EEPROM, flash memory and/or other memory technology. Further, the memory 504 is shown as internal to the system 500; however, the memory 504 can be internal, external or a combination of internal and external memory. The system 500 also may include a database (not shown in FIG. 5) as internal, external, or a combination of internal and external to the system 500. Additionally, the system typically includes a power supply (not shown), which may be rechargeable, and/or it may receive power from an external source. While FIG. 5 illustrates the various components being coupled together via a bus, it is understood that the various components may actually be coupled to the control circuit 502 and/or one or more other components directly.

Generally, the control circuit 502 and/or electronic components of the system 500 can comprise fixed-purpose hard-wired platforms or can comprise a partially or wholly programmable platform. These architectural options are well known and understood in the art and require no further description here. The system and/or control circuit 502 can be configured (for example, by using corresponding programming as will be well understood by those skilled in the art) to carry out one or more of the steps, actions, and/or functions described herein. In some implementations, the control circuit 502 and the memory 504 may be integrated together, such as in a microcontroller, application specification integrated circuit, field programmable gate array or other such device, or may be separate devices coupled together.

The I/O interface 506 allows wired and/or wireless communication coupling of the system 500 to external components and/or or systems. Typically, the I/O interface 506 provides wired and/or wireless communication (e.g., Wi-Fi, Bluetooth, cellular, RF, and/or other such wireless communication), and may include any known wired and/or wireless interfacing device, circuit and/or connecting device, such as but not limited to one or more transmitter, receiver, transceiver, etc.

The user interface 510 may be used for user input and/or output display. For example, the user interface 510 may include any known input devices, such one or more buttons, knobs, selectors, switches, keys, touch input surfaces, audio input, and/or displays, etc. Additionally, the user interface 510 include one or more output display devices, such as lights, visual indicators, display screens, etc. to convey information to a user, such as but not limited to communication information, instructions regarding ordering or shelving products, status information, order information, delivery information, notifications, errors, conditions, and/or other such information. Similarly, the user interface 510 in some embodiments may include audio systems that can receive audio commands or requests verbally issued by a user, and/or output audio content, alerts and the like.

Those skilled in the art will recognize that a wide variety of other modifications, alterations, and combinations can also be made with respect to the above described embodiments without departing from the scope of the invention, and that such modifications, alterations, and combinations are to be viewed as being within the ambit of the inventive concept.

What is claimed is:

1. A retail product distribution system comprising:
a shopping user interface configured to operate on an electronic user device of a customer of a retail store, the shopping user interface configured to provide an auction platform which is configured to register users;
a product database having product records stored therein; and
a control circuit in communication with the product database, the control circuit configured to:
receive auction data from the auction platform, the auction data including a bidding velocity for a particular product, a location of bidding users, and delivery location;
analyze the auction data and compare the bidding velocity of users for the particular product with a threshold velocity;
send instructions to a product purchasing system regarding a requested quantity of the particular product for a particular physical retail store if the bidding velocity of the particular product is above the threshold velocity;
send instructions to an electronic device of a worker of the retail store, the instructions regarding displaying the particular product at a primary display location if the bidding velocity of the particular product is above a primary threshold;
send instructions to the electronic device regarding displaying the particular product at a secondary display location if the bidding velocity of the particular product is below the primary threshold;
receive additional auction data from the auction platform, analyze the additional auction data to determine the bidding velocity of numerous auctioned products; and
send instructions to the electronic device regarding moving at least one displayed product from a first location to a second location based on the bidding velocity of the displayed particular product.

2. The retail product distribution system of claim 1 where the control circuit is configured to analyze at least one of the location of bidding users or the delivery location for the particular product to determine a regional bidding velocity for a particular geographic area.

3. The retail product distribution system of claim 2 wherein the control circuit is further configured to analyze the regional bidding velocity and compare it with the threshold velocity of at least one physical retail store within the particular geographic area.

4. The retail product distribution system of claim 1 wherein the auction platform is configured to present products for auction to the registered users of the shopping user interface and provide a predetermined period of time for the users to bid on the products presented.

5. The retail product distribution system of claim 1 wherein the control circuit is further configured to analyze the auction data to determine a demand price characterized by a decrease in the bidding velocity at the demand price.

6. The retail product distribution system of claim 5 wherein the control circuit sends instructions to the particular physical retail store to set a shelf price for the particular product as a function of the demand price.

7. The retail product distribution system of claim 1 wherein the product database further includes historical sales information and the control circuit is further configured to analyze the historical sales information and the auction data to determine an updated requested quantity of the particular product.

8. The retail product system of claim 1 wherein the auction data further includes number of views of the particular product, an initial bid price, number of bids received, times and amounts associated with the bids received, a winning bid, and an auction length.

9. A retail product distribution system configured to automatically order products and determine shelf location for the ordered products, the retail product distribution system comprising:
a product database having product records stored therein; and
a control circuit in communication with the product database, the control circuit configured to:
receive auction data from an electronic auction platform, the auction data including a number of views of a particular product, delivery location of the particular product, an initial bid price, number of bids received, times and amounts associated with the bids received, a winning bid amount, and an auction length;
analyze the auction data and identify a bidding velocity for a particular product in a regional area by identifying locations of bidding users;
obtain a first set of rules that identify an indicated product for a particular retail store as a function of the bidding velocity for the particular product in the regional area proximate the particular retail store as compared to a threshold velocity for the particular product;
send instructions to a product purchasing system regarding a requested quantity of the indicated product for the particular retail store;
obtain a second set of rules that identify a primary display product as a function of the bidding velocity in a regional area for the particular product as compared to a primary threshold for the particular product; and
send instructions to an electronic device associate with a worker regarding displaying the primary display product at a primary display location.

10. The retail product distribution system of claim 9 wherein the control circuit is further configured to generate a planogram for the particular retail store with at least primary display locations and secondary display locations determined as a function of the bidding velocity associated with various products, relative bidding velocity, and the locations of bidding users.

11. The retail product distribution system of claim 9 wherein the control circuit is further configured to update the product database to include the indicated product as being shelved at the particular retail store.

12. A method for determining whether and where to stock retail products, the method comprising:
receiving, at a control circuit, auction data from an electronic auction platform, the auction data including a number of views of a particular product, location of bidding users, an initial bid price, bids received, times and amounts associated with the bids received, a winning bid amount, and an auction length;
analyzing, via the control circuit, the auction data to identify a bidding velocity for the particular product;
sending instructions to a product purchasing system regarding a requested quantity of the particular product for a particular retail store if the bidding velocity of the particular product is above a threshold velocity for the particular retail store;
sending instructions to an electronic device associated with a worker at the particular retail store regarding displaying the particular product at a primary display location upon a determination that the bidding velocity of the particular product is above a primary threshold for the particular retail store; and
sending instructions to the worker electronic device regarding displaying the particular product at a secondary display location upon a determination that the bidding velocity of the particular product is below the primary threshold.

13. The method of claim 12 further comprising determining a regional bidding velocity and comparing the regional bidding velocity to the threshold velocity for the particular retail store to determine whether to send instructions to the product purchasing system requesting the particular product for the particular retail store.

14. The method of claim 12 further comprising analyzing the auction data to determine a demand price characterized by a decrease in the bidding velocity at the demand price and instructing the retail store to set a shelf price as a function of the demand price for the particular product.

15. A method for determining whether and where to stock retail products, the method comprising:
receiving, at a control circuit, auction data from an electronic auction platform, the auction data including a number of views of a particular product, location of bidding users, an initial bid price, bids received, times and amounts associated with the bids received, a winning bid amount, and an auction length;
analyzing, via the control circuit, the auction data to identify a bidding velocity for the particular product;
obtaining a first set of rules that identify an indicated product for a particular retail store as a function of the bidding velocity for the particular product in a geographic area proximate the particular retail store as compared to a threshold velocity for the particular product;
sending instructions to a product purchasing system regarding a requested quantity of the indicated product for a particular retail store;
obtaining a second set of rules that identify a primary display product as a function of the bidding velocity for the particular product as compared to a primary threshold for the particular product; and
sending instructions to an electronic device associated with a worker regarding displaying the primary display product at a primary display location.

16. The method of claim 15 further comprising determining a regional bidding velocity and comparing the regional bidding velocity to the threshold velocity for the particular retail store to determine whether to send instructions to the product purchasing system requesting the particular product for the particular retail store.

17. The method of claim 15 further comprising analyzing the auction data to determine a demand price characterized by a decrease in the bidding velocity at the demand price and instructing the retail store to set a shelf price as a function of the demand price for the particular product.
